(19) United States
(12) Patent Application Publication
(10) Pub. No.: US 2004/0167961 A1
(43) Pub. Date: Aug. 26, 2004

(54) Fragment response cache

(75) Inventors: Neel Kamal Jain, Redmond, WA (US); Chun Ye, Sammamish, WA (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Microsoft Corporation, Redmond, WA

(21) Appl. No.: 10/375,840

(22) Filed: Feb. 26, 2003

(51) Int. Cl. G06F 15/16; G06F 13/28; G06F 13/00; G06F 12/16; G06F 12/14; G06F 12/00

(52) U.S. Cl. 709/203; 711/113

(57) ABSTRACT

The invention is directed to methods and data structures that enable a server to respond to a request for a web page by storing data fragments that are at least partially responsive to the request in a cache that is resident in kernel mode physical memory. The cache, a fragment cache, enables the server to respond efficiently, by receiving the request in a kernel mode; composing a response to the request by addressing the fragment cache in kernel mode to retrieve one or more data fragments at least partially responsive to the request; and transforming the data fragments into a composed response. The data fragments are addressable via a universal resource locator (URL) and in a hierarchical data structure, and are addressable by an application responding to the request.

### FIELD OF THE INVENTION

This invention relates generally to computer systems and, more particularly, relates to a system and method for a fragment response cache for computer systems and computer devices.

### BACKGROUND OF THE INVENTION

All of over the world, people increasingly rely on the Internet to communicate and conduct business. The Internet provides vast benefits including connectivity and availability of data and systems. Through the Internet, people expect instant access to a plethora of diverse sources of information. To accommodate that expectation, web servers must be reliable, perform and provide security features while also providing web services and a large number of requests.

With the increased usage of the Internet, commercial Web sites that provide e-commerce and services must be capable of enabling applications to use and exploit Web servers. Competitive Web sites must be capable of guaranteeing high availability and high speed of delivery in the processing and execution of dynamic Web pages. A Web server's core task in this regard is to handle HTTP requests quickly, reliably and securely. Accordingly, what is needed is a system able to handle HTTP requests in a manner that guarantees the high speeds and added features required for today's Internet.

### BRIEF SUMMARY OF THE INVENTION

Accordingly, embodiments of the present invention are directed to methods and data structures that enable a server to respond to a request for a web page by storing data fragments that are at least partially responsive to the request in a cache that is resident in kernel mode memory. The cache, a fragment cache, enables the server to respond efficiently, by receiving the request in a kernel mode; composing a response to the request by addressing the fragment cache in kernel mode to retrieve one or more data fragments at least partially responsive to the request; and transforming the data fragments into a composed response. The data fragments are addressable via a universal resource locator (URL) and in a hierarchical data structure, and addressable by an application responding to the request.

One embodiment is directed to a method for a server to respond to a request, and includes receiving the request in a kernel mode, parsing the request in the kernel mode, identifying one or more content fragments stored in kernel mode, the content fragments at least partially responsive to the request, and interacting with a responsible application, the responsible application controlling a response to the request. The controlling the response can include adding content to the response prior to sending the response and altering the content. The controlling can also include having the application send the response without alteration.

Another embodiment is directed to a method for a user mode component to interact with a kernel mode cache configured to hold one or more data fragments responsive to a URL request. More particularly, the method includes several APIs, including an API configured to store the data fragments in the kernel mode cache, an API configured to flush the data fragments and any data fragments that are hierarchical descendants, an API configured to read the data fragments from the kernel mode cache, and an API configured to send a response using the data fragments from the kernel mode cache.

Additional features and advantages of the invention will be made apparent from the following detailed description of illustrative embodiments, which proceeds with reference to the accompanying figures.

### BRIEF DESCRIPTION OF THE DRAWINGS

While the appended claims set forth the features of the present invention with particularity, the invention, together with its objects and advantages, can be best understood from the following detailed description taken in conjunction with the accompanying drawings of which:

FIG. 1 is a block diagram generally illustrating an exemplary computer system on which the present invention resides;

FIG. 2 is block diagram of an exemplary architecture of a Web server in accordance with an embodiment of the present invention.

FIG. 3 is a block diagram of an exemplary architecture of a kernel mode portion of a Web server.

FIG. 4 is a flow diagram illustrating a method according to an embodiment of the present invention.

### DETAILED DESCRIPTION OF THE INVENTION

Turning to the drawings, wherein like reference numerals refer to like elements, the invention is illustrated as being implemented in a suitable computing environment. Although not required, the invention will be described in the general context of computer-executable instructions, such as program modules, being executed by a personal computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multi-processor systems, microprocessor based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices.

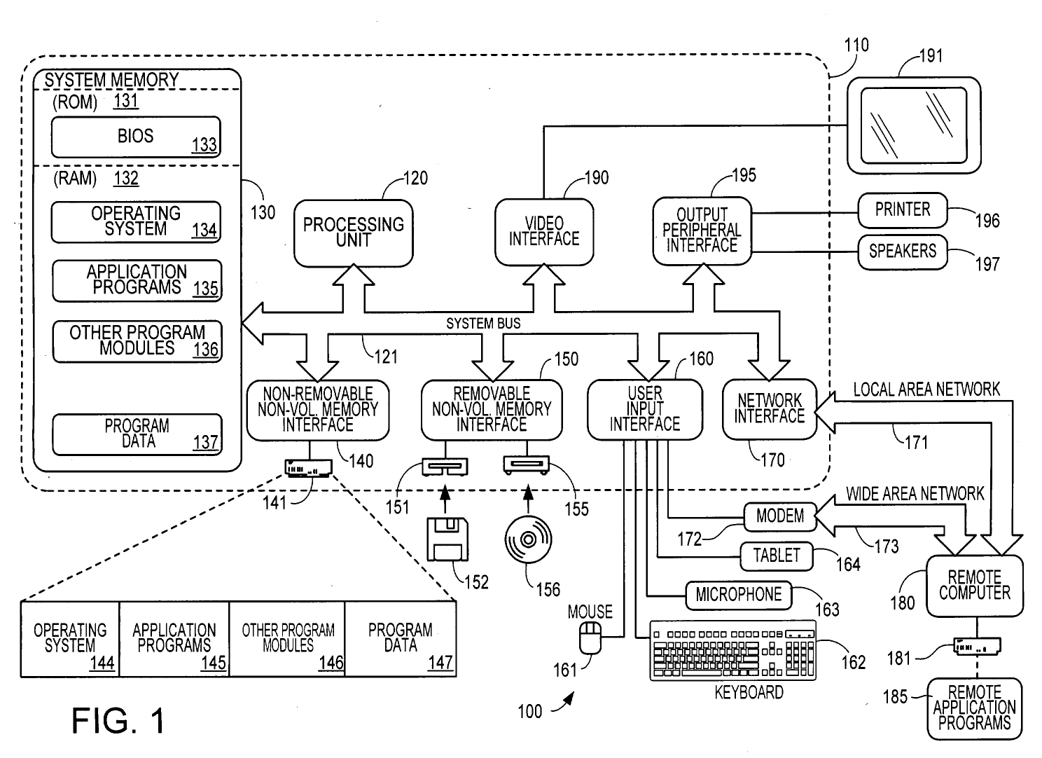

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 110 typically includes a variety of computer readable media. Computer readable media can be any available media that can be accessed by the computer 110 and includes both volatile and nonvolatile media, and removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136 and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146 and program data 147. Note that these components can either be the same as or different from operating system 134, application programs 135, other program modules 136, and program data 137. Operating system 144, application programs 145, other program modules 146, and program data 147 are given different numbers hereto illustrate that, at a minimum, they are different copies. A user may enter commands and information into the computer 110 through input devices such as a tablet, or electronic digitizer, 164, a microphone 163, a keyboard 162 and pointing device 161, commonly referred to as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. The monitor 191 may also be integrated with a touch-screen panel or the like. Note that the monitor and/or touch screen panel can be physically coupled to a housing in which the computing device 110 is incorporated, such as in a tablet-type personal computer. In addition, computers such as the computing device 10 may also include other peripheral output devices such as speakers 197 and printer 196, which may be connected through an output peripheral interface 194 or the like.

The computer 10 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet. For example, in the present invention, the computer system 10 may comprise the source machine from which data is being migrated, and the remote computer 180 may comprise the destination machine. Note however that source and destination machines need not be connected by a network or any other means, but instead, data may be migrated via any media capable of being written by the source platform and read by the destination platform or platforms.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

In the description that follows, the invention will be described with reference to acts and symbolic representations of operations that are performed by one or more computers, unless indicated otherwise. As such, it will be understood that such acts and operations, which are at times referred to as being computer-executed, include the manipulation by the processing unit of the computer of electrical signals representing data in a structured form. This manipulation transforms the data or maintains it at locations in the memory system of the computer, which reconfigures or otherwise alters the operation of the computer in a manner well understood by those skilled in the art. The data structures where data is maintained are physical locations of the memory that have particular properties defined by the format of the data. However, while the invention is being described in the foregoing context, it is not meant to be limiting as those of skill in the art will appreciate that various of the acts and operation described hereinafter may also be implemented in hardware.

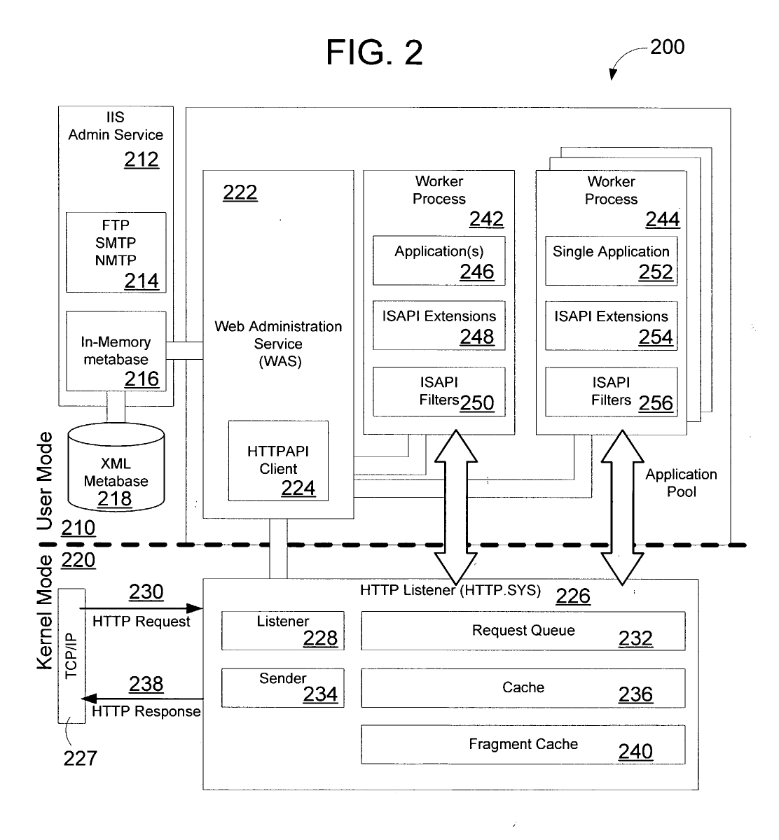

Referring to FIG. 2, an exemplary overview block diagram illustrates an architecture of a Web server 200 including a fragment cache system according to an embodiment. More particularly, Web server 200 includes a user mode component 210 and a kernel mode component 220. Within the user mode component an Internet Information Service (IIS) 212 includes a file transfer protocol (FTP), simple mail transfer protocol (SMTP), and network news transfer protocol (NNTP) component 214 and an in-memory metabase 216. Metabase 216 can store web site and application configuration information. The information can be stored using extensible markup language (XML). In-memory metabase 216 is coupled to XML metabase 218, which is a database holding metadata in XML format. IIS 212 is coupled to a web administration service (WAS) 222, including an hyper-text transfer protocol (HTTP) application programming interface (API) client 224. WAS 222 can be used to configure server and worker processes and ensure that worker processes are not started until there is a request for a web application. One function of WAS 222 can include monitoring processes to prevent memory leaks. WAS 222 is coupled to kernel mode component 220 and specifically to HTTP.SYS 226. WAS 222 and HTTP.SYS 226 together can be configured to operate independent of third-party code, thereby keeping main web server functionality and having application code run in dedicated independent server processes, shown as worker processes 242 and 244. WAS 22 can be responsible for configuring HTTP.SYS 226 and worker processes 242 and 244. HTTP.SYS 226 is a kernel-mode driver and includes listener component 228 that receives HTTP requests 230. HTTP.SYS 230 can be implemented as a single point of contact for incoming HTTP requests. HTTP.SYS 226 is coupled to transmission control protocol/internet protocol (TCP/IP) 227 and can be configured to receive all connection requests from the selected TCP ports. HTTP.SYS can be configured to provide services including connection management, bandwidth throttling, and Web server logging. Listener component 228 is coupled to request queue 232 to store requests to be processed. HTTP.SYS 226 further includes sender component 234 that responds to HTTP requests by matching entries in cache 236 and providing an HTTP response 238. According to an embodiment, HTTP.SYS 226 further includes a fragment cache 240 that also interacts with sender component 234 to produce a response, as explained in more detail below.

HTTP.SYS 226 interacts with worker process 242 and worker process 244, which represents one or more worker processes. Worker process 242 includes an application 246, Internet server application programming interface (ISAPI) Extensions 248 and ISAPI Filters 250. Worker process 244 includes a single application 252, ISAPI extensions 254 and ISAPI filters 256. Both worker process 242 and worker process 244 can interact with WAS 222 and HTTP.SYS 226 via HTTP API 224 to respond to HTTP requests 230.

A request received at TCP/IP 227 can be either a request for dynamic or static content. Commonly, a web page request results in requests for both dynamic and static content. For dynamic content, requests are typically received at TCP/IP 227 and transmitted via HTTP request 230 to listener 228, all of which are in kernel mode 220. HTTP.SYS 226 interacts via an HTTP API 224 to transmit the request to user mode 210 for an appropriate worker process 242 or 244 responsible for the dynamic content required by the request. Applications 246, 252 within the responsible worker process 242, 244 that are designated as appropriate for handling the request typically interact with a database to provide the dynamic content. The filled request is then transmitted back to kernel mode 220 to sender 234 and HTTP response 238 for transmittal via TCP/IP 227.

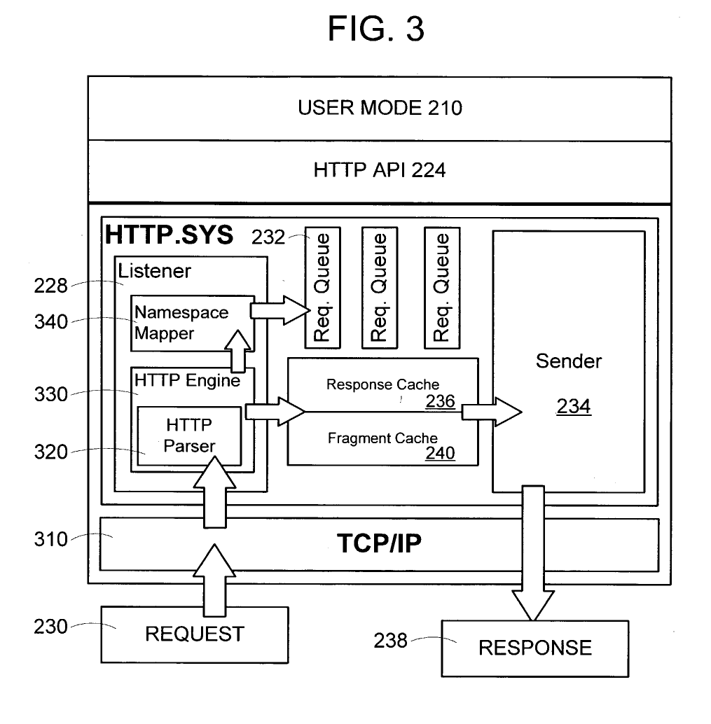

Referring now to FIG. 3, the flow of a request through only kernel mode 220 is illustrated. A request that is serviced only in kernel mode is responded to quickly. More particularly, kernel mode treats such requests with lower latency than user mode. As shown, a request 230 is received at TCP/IP component 310. TCP/IP component 310 passes the request to listener 228, which receives the request at HTTP Engine 330 and the request is parsed in HTTP parser 320. Request 230 passes to a namespace mapper 340 and then passes to a request queue 232. After queuing, HTTP engine 330 passes the request to response cache 236. Response cache 236 can compose a response entirely of kernel mode stored data. A typical response can include receiving a URL request 230, matching the URL to an entry in response cache 236 and sending the response via sender component 234 as HTTP response 238 using content from cache 236. Such a response requires no interaction with user mode 210. Avoiding processing the request in user mode 210 saves processing time and resources.

Referring back to FIG. 2, an embodiment is directed to extending the HTTP.SYS response cache by providing fragment cache 240, which can be implemented as a separate cache component or as part of cache 236. Unlike the flow of either a typical response using both kernel mode 220 and user mode 210, or the flow of a request filled only in kernel mode 220, according to the embodiment, applications can interact with fragment cache 240 instead of interacting with a database to fill responses. Thus, the benefit of having the efficiency of filling the request in kernel mode is maintained by having applications 246, 252 call content for creating a response to a request using fragment cache 240, which is in kernel mode 220. Fragment cache 240 can be configured to hold portions of a web page that are expensive to construct by an application, that would be time consuming to pull from a database. For example, complicated static content, images and the like can be stored in fragment cache 240 and quickly retrieved from physical memory. In one embodiment, applications, such as 246, 252 first load fragment cache 240 with static copies of content such as content that would require a lengthy database lookup. Then, when a URL request is received by HTTP.SYS, HTTP.SYS 226 parses the request to determine whether the request can be serviced by, for example, a kernel mode response or a user mode response, which will require user-mode processing. For a user mode response, the application 246 or 252 determines that a fragment cache 240 response can take place by sending a response that contains data chunks that reference entries in fragment cache 240. The data chunk contains a URL to identify content in fragment cache 240.

Next, HTTP.SYS can assemble the fragments if the URLs match entries in fragment cache 240. The API associated with fragment cache 240 can be implemented as part of HTTP API 224, can be a dedicated fragment cache 240 API, or the like, as determined by system requirements.

Using a kernel mode cache such as fragment cache 240 for content eliminates the need for responses that have to be fully regenerated via a lookup in a database for each request. The elimination of the filling the request in user mode 210 provides a fast response with marked performance improvement from responses that require user-mode interactions with databases.

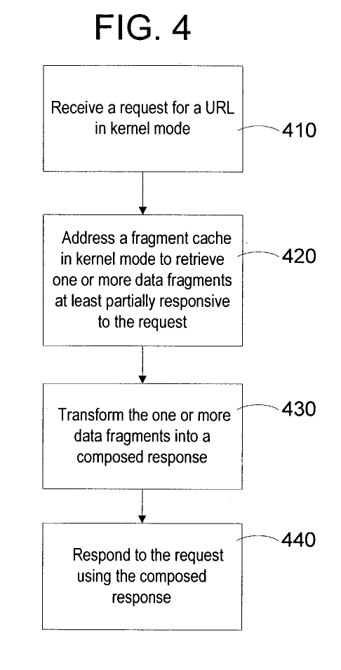

Referring now to FIG. 4, a flow diagram illustrates an embodiment in which fragment cache 240 composes responses. In the embodiment, fragment cache 240 composes a response to such requests. Block 410 provides for receiving a request for a URL, such as by HTTP.SYS 226 in kernel mode. Block 420 provides for addressing a fragment cache in kernel mode to retrieve one or more data fragments at least partially responsive to the request. Block 430 provides for transforming the one or more data fragments into a composed response. The transforming includes contacting a responsible application. In one embodiment, the application determines whether additional or altered content should be added to the response. Block 440 provides for responding to the request using the composed response.

Because physical memory is limited, adding a fragment to fragment cache 240 may not guarantee that it is available for future calls to send a response. Rather, fragment cache entries can become unavailable at any time. A call that uses a fragment that is not available fails. Therefore, applications that use fragment cache 240 are, according to an embodiment, able to handle this failure. For example, if a failure occurs, an application can provide for adjusting the call to provide a user mode response.

To implement fragment cache 240, fragments in fragment cache 240 can be addressable via hierarchically stored universal resource locators (URLs). Thus, to form a response, fragments can be added by concatenating partial response fragments retrieved from fragment cache 240 with data or content retrieved from other sources. In an embodiment, applications 246, 252 interact with HTTP.SYS 226 via HTTP API 224, having HTTP.SYS 226 retrieve the fragments and add headers as necessary at sender 234. By providing that each fragment is addressable as a URL, a difference between fragment cache 240 and response cache 238 is that instead of each response being a named response, as is the case for responses filled by response cache 236, each fragment is a named fragment in fragment cache 240. Because each fragment is addressable via a URL, each fragment is named and can be called by name to create a response. Thus, HTTP.SYS 226 calls a fragment from fragment cache 240 by name, and APIs that call any fragments from fragment cache 240 can operate using URL names. Because the fragments are named using URLs, the fragments can be organized in a hierarchical structure, which assists in building responses and web pages.

Fragments are data fragments without headers and other required transport indicia. Thus, a full response except for required transport indicia qualifies as a fragment and would not qualify as a match in cache 236. Instead, even though the fragment would be a full response except for the transport indicia, HTTP.SYS 226 passes the request to the application responsible for the response. Thus, responses that require policies to be enforced, which can include security policies, value added service policies, and the like can benefit from having kernel mode stored data, but with added content/altered content. For example, if a response is required for an international web site, providing the full response in fragment cache 240 minus necessary headers, will cause HTTP.SYS 226 to direct the request to the responsible application. For an international web page, for example, the responsible application can analyze the request and respond in an appropriate fashion, by, for example, first reading the response stored in the fragment cache and then altering the response language to match the request. The response can be formed of data fragments from fragment cache 240, under the control of an application. ** Thus, the response is sent efficiently using kernel mode fragment cache 240, with only a portion of the content from a user mode source.

Referring back to FIG. 2, embodiments are directed to the application programming interfaces (APIs) used to provide functionality to fragment cache 240. HTTP API 224 provides functionality for components in user mode to store data fragments in fragment cache 240 for use in rapidly forming HTTP responses 238. HTTP API 224 can include several APIs for enabling an application to interact with fragment cache 240. One HTTP API function includes the ability to add fragments to fragment cache 240. Specifically, an application such as applications 246 and 252 can add fragments to fragment cache 240 by calling the API HttpAddFragmentToCache function. A fragment is identified by a URL contained in a data structure such as a pFragmentName parameter. A call to this function with the URL of an existing fragment overwrites the existing fragment. To implement API HttpAddFragmentToCache, an application or other user mode component accesses fragments via HTTP.SYS 226 and the naming protocol for the fragments.

Applications can also delete a fragment from fragment cache 240 or overwrite fragments if an application is identified as an “owner” of a fragment. Specifically, an owner associated with request queue 232 that initially added the fragment can delete the fragment. The API HttpFlushResponseCache function, called with a URL prefix, deletes the fragment specified by the URL prefix, or if the FLUSH_RECURSIVE flag is set, deletes all fragments within that prefix as well as the hierarchical descendants of that URL prefix.

An API HttpReadFragmentFromCache function reads in the entire fragment or a specified byte range within the fragment.

Another API for addressing fragment cache 240 provides for sending a response with a fragment. As discussed above, fragments can be used to form all or portions of an HTTP response entity body. Using API HttpSendHttpResponse function, an application can send a response and an entity body in one call.

Regarding data structures, to use fragments, an application or other user mode component specifies an array of data structures, called HTTP_DATA_CHUNK structures within the data structure for the response, the HTTP_RESPONSE structure.

The data structure HTTP_DATA_CHUNK can specify a block of memory, which can be a handle to an already-opened file or a fragment cache entry. The entries correspond to the HTTP_DATA_CHUNK types: HttpDataChunkFromMemory, HttpDataChunkFromFileHandle, and HttpDataChunkFromFragmentCache, respectively. Full responses in the HTTP cache can also be used as fragments in the HTTP_RESPONSE structure.

The HTTP_RESPONSE structure contains a pointer to an array of HTTP_DATA_CHUNK structures that comprise the entity body of the response. The HTTP_RESPONSE structure also contains a matching count that specifies the dimension of the array of HTTP_DATA_CHUNK structures.

The HttpDataChunkFromFragmentCache value in the HTTP_DATA_CHUNK structure specifies the fragment cache type of the data chunk. The HTTP_DATA_CHUNK structure also specifies the fragment name.

A response that contains a cached fragment fails with an ERROR_PATH_NOT_FOUND if any of the fragment cache entries are not available. Since the fragment cache entries are not guaranteed to be available, applications that use fragment cache 240 can be configured to handle such errors. One way to handle this case is to attempt to re-add the fragment cache entry and resend the response. If repeated failures occur, the application can generate the data again and send it using a data chunk HttpDataChunkFromMemory instead of fragment cache entries.

Fragment cache entries can also be specified in the HttpSendResponseEntityBody function. The fragment is added to the entity body in the HTTP_DATA_CHUNK structure. The send can fail if any of the specified fragment cache entries are not available.

In view of the many possible embodiments to which the principles of this invention can be applied, it will be recognized that the embodiment described herein with respect to the drawing figures is meant to be illustrative only and are not be taken as limiting the scope of invention. For example, those of skill in the art will recognize that the elements of the illustrated embodiment shown in software can be implemented in hardware and vice versa or that the illustrated embodiment can be modified in arrangement and detail without departing from the spirit of the invention. Therefore, the invention as described herein contemplates all such embodiments as can come within the scope of the following claims and equivalents thereof.

We claim:

1. A method of responding to a request for a web page, the method comprising:
receiving the request in a kernel mode;
composing a response to the request, the composing including:
addressing a fragment cache in kernel mode to retrieve one or more data fragments at least partially responsive to the request; and
transforming the one or more data fragments into a composed response; and
responding to the request using the composed response.

2. The method of claim 1 wherein the data fragments are addressable via a universal resource locator (URL).

3. The method of claim 1 wherein an HTTP driver receives the request in the kernel mode.

4. The method of claim 1 wherein the one or more data fragments are addressable by an application responding to the request.

5. The method of claim 1 wherein the transforming the data fragments includes adding a header to the one or more data fragments.

6. The method of claim 1 wherein the composing the response and the responding occurs in kernel mode and independent of a user mode.

7. A method for a server to generate a response to a request, the method comprising:
receiving the request in a kernel mode;
parsing the request in the kernel mode;
interacting with a responsible application, the responsible application controlling the response to the request;
processing the request in the application, the processing including identifying one or more content fragments stored in kernel mode, the content fragments at least partially responsive to the request; and
composing the response in kernel mode using the identified content fragments.

8. The method of claim 7 wherein the processing the request includes specifying one or more offsets and one or more lengths from any files specified by the application, the files being at least partially responsive to the request.

9. The method of claim 7 further comprising:
providing a sequence of content fragment identifiers and data buffers; and
providing an order for the sequence of content fragment identifiers and data buffers.

10. The method of claim 7 wherein the composing the response in kernel mode further includes adding data from one or more files identified by the application.

11. The method of claim 7 wherein the composing the response in kernel mode further includes adding one or more data buffers provided by the application from a memory associated with the application, the data buffers at least partially responsive to the request.

12. The method of claim 7 wherein the composing the response in kernel mode further includes adding one or more headers provided by the application.

13. The method of claim 12 wherein the headers are hyper text transfer protocol (HTTP) headers.

14. The method of claim 7 wherein the composing the response in kernel mode further includes adding one or more headers as determined in kernel mode.

15. A computer readable medium having computer executable instructions for performing the method of claim 7.

16. A method for a server to respond to a request, the method comprising:
receiving the request in a kernel mode;
parsing the request in the kernel mode;
interacting with a responsible application, the responsible application controlling a response to the request; and
identifying one or more content fragments stored in kernel mode, the content fragments at least partially responsive to the request.

17. The method of claim 16 wherein the controlling the response to the request includes one of adding content and sending the response, altering content and sending the response, and sending the response without altering or adding to the content.

18. A computer readable medium having computer executable instructions for performing a method of responding to a request for a web page, the method comprising:
receiving the request in a kernel mode, the method comprising:
receiving the request in a kernel mode;
composing a response to the request, the composing including:
addressing a fragment cache in kernel mode to retrieve one or more data fragments at least partially responsive to the request; and
transforming the one or more data fragments into a composed response; and
responding to the request using the composed response.

19. A computer readable medium having computer executable instructions for performing a method for a server to respond to a request, the method comprising:
receiving the request in a kernel mode;
parsing the request in the kernel mode;
identifying one or more content fragments stored in kernel mode, the content fragments at least partially responsive to the request; and
interacting with a responsible application, the responsible application controlling a response to the request.

20. The computer readable medium of claim 19 wherein the controlling the response to the request includes one of adding content and sending the response, altering content and sending the response, and sending the response without altering or adding to the content.

21. A method for an a user mode component to interact with a kernel mode cache configured to hold one or more data fragments responsive to a universal resource locator (URL), the method comprising:
calling a first application programming interface (API) configured to store the data fragments in the kernel mode cache, each of the data fragments identified by a URL;
calling a second API configured to flush the data fragments and any data fragments that are hierarchical descendants;
calling a third API configured to read the data fragments from the kernel mode cache; and
calling a fourth API configured to send a response using the data fragments from the kernel mode cache.

22. The method of claim 21 wherein the first API functions to overwrite any existing associated data fragment in the kernel mode cache.

23. The method of claim 21 wherein the data fragments are identified by a URL contained in a data structure pFragmentName and the first API is an AddFragmentToCache API.

24. The method of claim 21 wherein the second API is a FlushResponseCache API called with a URL prefix, the identification of the URL prefix enabling the second API to delete the data fragments within the URL prefix and the hierarchical descendants.

25. The method of claim 21 wherein the third API is a ReadFragmentFromCache API enabling reading of a data fragment from the kernel mode cache and enabling reading of a portion of a data fragment if the portion is identified.

26. The method of claim 21 wherein the fourth API is a SendHttpResponse API configured to send a response with one or more of the data fragments.

27. A structure for enabling an application to interact with a kernel mode cache holding one or more data fragments, the data fragments capable of at least partially forming a response to a universal resource locator request received by a server, the structure comprising:
a response data structure; and
an array of data structures within the response data structure, wherein each data structure of the array is configured to specify a block of memory and a name of an associated data fragment.

28. The structure of claim 27 wherein the array of data structures are each HTTP_DATA_CHUNK structures, and the response data structure is an HTTP_RESPONSE structure.

29. The structure of claim 27 wherein each of the data structures in the array of data structures has one of a plurality of types, the plurality of types including: HttpDataChunkFromMemory, HttpDataChunkFromFileHandle, and HttpDataChunkFromFragmentCache.

30. The structure of claim 27 wherein the response data structure is configured to use a full response from the kernel mode cache.

31. The structure of claim 27 wherein the response data structure is configured to provide a matching count that specifies the dimension of the array of data structures.

32. The structure of claim 27 wherein the memory is a physical memory.
